(19) United States
(12) Patent Application Publication
(10) Pub. No.: US 2004/0165798 A1
(43) Pub. Date: Aug. 26, 2004

(54) Eccentric bearing for a poppet drive system

(76) Inventor: Jorge A. Valdespino, El Paso, TX (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/375,319

(22) Filed: Feb. 26, 2003

(51) Int. Cl. F16C 19/50

(52) U.S. Cl. 384/447

(57) ABSTRACT

An eccentric bearing for driving pump poppets, wherein the motor shaft is non-eccentric and no U-shaped follower is used. The eccentric bearing has an inner bearing cylinder, an outer bearing ring and a roller or ball bearing interfacing between the inner bearing cylinder and the outer bearing ring. A shaft bore is provided in the inner bearing cylinder at a location off-set from the axial center of the inner bearing cylinder. A non-eccentric shaft (that is, the shaft rotates symmetrically about its axis of rotation) is affixed to the shaft bore, and the mass is centrifugally balanced in the inner bearing cylinder. A pair of poppet head clips are attached to an outer bearing surface of the outer bearing ring for clipping onto diametrically disposed poppet heads.

### TECHNICAL FIELD

The present invention relates to bearings used to actuate pump poppets, and more particularly to a quick engage eccentric bearing which provides poppet actuation utilizing a non-eccentric motor shaft.

### BACKGROUND OF THE INVENTION

Modulator pumps have reciprocating poppets to effect pumping. Various aspects of a conventional poppet drive system 10 are shown in FIGS. 1 through 3.

A pair of axially opposed poppets 12, 14 are provided, each poppet being connected to a respective modulator pump. Each poppet 12, 14 has a poppet head 16, 16′ featuring a drive slot 18, 18′ and a drive surface 20, 20′. A U-shaped follower 22 has, at each end thereof, a drive clip 24. Each drive clip 24 is clipped onto a respective drive slot 18, 18′. In order to actuate the poppets 12, 14, a bearing 26 is interfaced with an eccentric shaft 28 of an electric motor. The eccentricity of the eccentric shaft 28 is defined by an overset 28a on one side and an under-set 28b on the opposing side. The bearing 26 is symmetrical and disposed within the U-shaped follower 22. The bearing is composed of an inner bearing ring, 26a, and outer bearing ring 26b, and a roller or ball bearing interfacing between the inner and outer rings. The inner bearing ring 26a is affixed to the eccentric shaft 28 and the outer bearing ring 26b has an outer bearing surface 26c which abuts the drive surface 20, 20′ of each of the poppet heads 16, 16′. In this regard, the U-shaped follower 22 is springably resilient such that the drive clips 24 are mutually biased toward each other when the drive clips are seated in the drive slots 18, 18′, thereby forcing the drive surface 20, 20′ of both of the poppet heads 16, 16′ to slidably follow the outer bearing surface 26c.

In operation, as the eccentric shaft 28 rotates, the inner bearing ring 26a of the bearing 26 rotates in unison with the eccentric shaft. However, since the outer bearing ring 26b is bearingly (roller or ball) interfaced with the inner bearing ring, the outer bearing ring may be stationary as the inner bearing ring rotates with the eccentric shaft. As the eccentricity of the eccentric shaft exhibits itself over 360 degrees of rotation, the outer bearing ring shifts linearly on a drive axis A (the drive axis is also the axis of alignment of the poppets). Accordingly, each poppet is serially driven in opposite directions along the drive axis A. In this regard, as the eccentric shaft over-set 28a becomes located at the drive surface of a poppet, the over-set pushes against the drive surface and overcomes the biasing of the U-shaped follower such that the poppet head moves in one direction; then, as the under-set 28b becomes located at the drive surface, the poppet head moves in the opposite direction by the biasing of the U-shaped follower.

Unfortunately, there are several drawbacks with the conventional poppet drive system. The motor is unique and expensive, in that it must have an eccentric shaft and internal components which assure rotary balancing of the eccentric shaft. Further, the U-shaped follower is a necessary component expense and can be subject to fatigue.

What remains needed in the art is a poppet drive system which does not have any of the aforementioned drawbacks.

### SUMMARY OF THE INVENTION

The present invention is an eccentric bearing for driving poppets of a pump, wherein the motor shaft is non-eccentric and no U-shaped follower is used.

An eccentric bearing according to the present invention is utilized to drive a pair of opposed pump poppets, wherein the eccentric bearing is connected to a non-eccentric shaft of a drive motor. In this regard, the eccentric bearing has an inner bearing cylinder, an outer bearing ring and a roller or ball bearing interfacing between the inner bearing cylinder and the outer bearing ring. A shaft bore is provided in the inner bearing cylinder at a location off-set from the axial center of the inner bearing cylinder. A non-eccentric shaft (that is, the shaft rotates symmetrically about its axis of rotation) is affixed to the shaft bore. In order to ensure rotary balance of the inner bearing, a balancing cavity is formed in the inner bearing cylinder off-set from the axial center of the inner bearing cylinder, wherein the shaft bore and the balancing cavity are diametrically opposite with respect to the axial center of the inner bearing cylinder. A pair of poppet head clips are attached to an outer bearing surface of the outer bearing ring, wherein the poppet head clips are in mutual alignment.

In operation, each poppet head clip is clipped onto a respective poppet head drive slot. In this regard, the poppet heads must follow movements of the outer bearing ring, since the poppet head clips and outer bearing surface are in an interfering relation with poppet heads in both directions of the poppet drive axis. As the shaft rotates, the inner bearing cylinder rotates eccentrically about the shaft. As a result, the outer bearing ring, which is not rotating by virtue of the roller or ball bearing interface between the inner bearing cylinder and the outer bearing ring, reciprocates back and forth along the poppet drive axis. This reciprocation effects reciprocation of each of the poppet heads.

Accordingly, it is an object of the present invention to provide a poppet drive system which uses a non-eccentric shaft and does not use a U-shaped follower.

This and additional objects, featuring and advantages of the pringent invention will become clearer from the following specification of a preferred embodiment.

### BRIEF DESCRIPTION OF THE DRAWINGS

FIG. 1 is a perspective view of a prior art poppet drive system.

FIG. 2 is an end view of the bearing and U-shaped follower of the prior art poppet drive system of FIG. 1.

FIG. 3 is an en end view of the eccentric shaft and U-shaped follower of the prior art poppet drive system of FIG. 1.

FIG. 4 is a perspective view of an eccentric bearing according to the present invention.

FIG. 5 is a sectional view of the eccentric bearing, seen along line 5-5 of FIG. 4.

FIGS. 6A and 6B depict end views of a poppet drive system according to the present invention, utilizing the eccentric bearing of FIG. 4, wherein the reciprocation is of the poppets is demonstrated.

FIG. 7 is a perspective view of the poppet drive system of FIG. 6, now showing a portion of the drive motor.

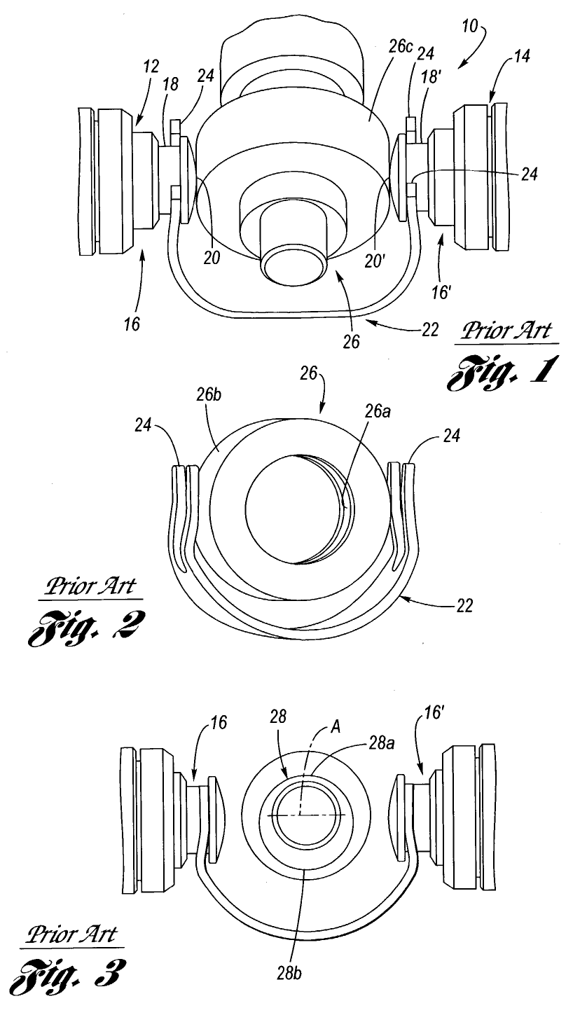

### DESCRIPTION OF THE PREFERRED EMBODIMENT

Referring now to the Drawing, FIGS. 4 through 7 depict various aspects of a poppet drive system 100 according to the present invention which system features an eccentric bearing 102. The poppet drive system uses conventional poppets 12, 14 axially aligned along a poppet drive axis A. Each poppet is connected to a respective modulator pump. Each poppet 12, 14 has a poppet head 16, 16′ featuring a drive slot 18, 18′ and a drive surface 20, 20′.

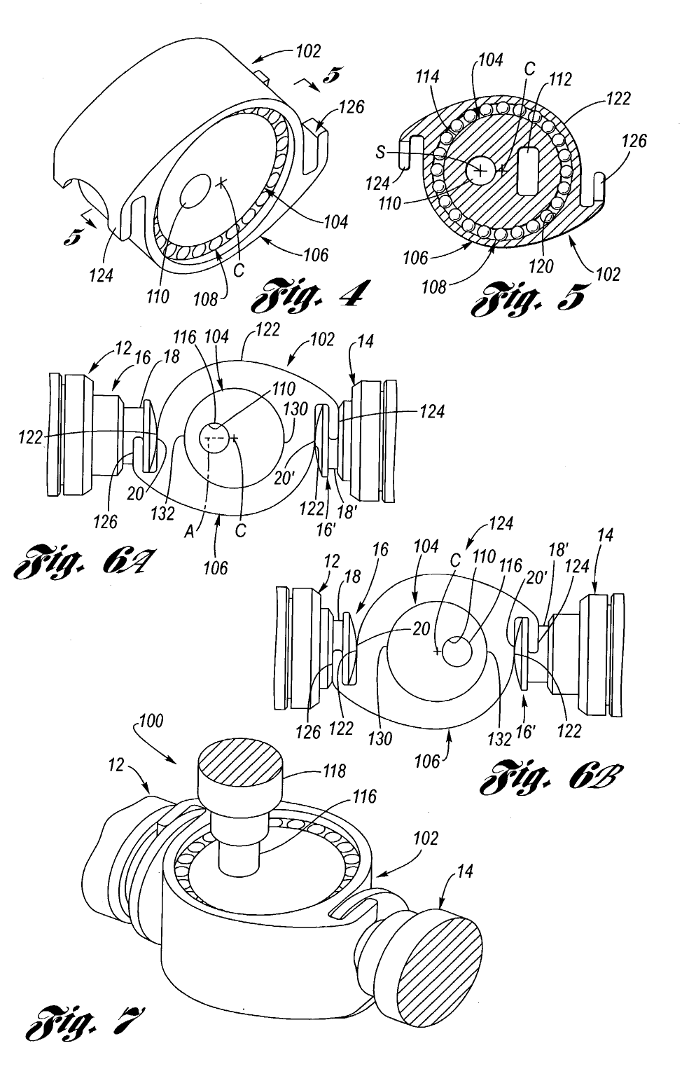

Referring firstly to FIGS. 4 and 5, the eccentric bearing 102 will be detailed, wherein the eccentric bearing 102 has an inner bearing cylinder 104, an outer bearing ring 106 and a roller or ball bearing 108 interfacing between the inner bearing cylinder and the outer bearing ring.

The inner bearing cylinder 104 is has (most preferably) a solid body, except for a shaft bore 110 and a balancing cavity 112, wherein the outer periphery 114 of the inner bearing cylinder is circular with respect to an axial center C, and rollably interfaces with the annular shaped ball or roller bearing 108. The shaft bore 110 is formed in the inner bearing cylinder 104 at a location off-set from (that is, spaced in relation to) the axial center C of the inner bearing cylinder. The distance of the off-set (the distance from the axial center C to the center S of the shaft bore 110 is predetermined to provide a desired eccentric rotation of the inner bearing cylinder as it rotates about the center of the shaft bore, wherein the manner of the eccentric rotation will described more fully hereinbelow.

In that the rotation of the inner bearing cylinder 104 is eccentric, mass must be distributed therewithin to ensure balanced centrifugal forces during rotation. The balancing cavity 112 ensures rotary balance of the inner bearing cylinder 104 as it rotates about the center S of the shaft bore 110. In this regard, the balancing cavity 112 is off-set from (spaced in relation to) the axial center C of the inner bearing cylinder 104, wherein the shaft bore 110 and the balancing cavity 112 are diametrically opposite with respect to each other in an imaginary line passing through the axial center C of the inner bearing cylinder 104.

The outer bearing ring 106 has a circular inner periphery 120 which interfaces with the above described roller or ball bearing 108. The outer bearing ring 106 further has an outer bearing surface 122. A poppet head clip 124, 126 is attached, as for example integrally (as shown) or attached by any suitable modality such as by spot welding (for metal), adhesive or sonic welding (for plastic), to the outer bearing surface 122, wherein the poppet head clips are located in mutual axial alignment.

Referring now additionally to remaining FIGS. 6A through 7, a non-eccentric shaft 116 (that is, the shaft is configured to rotate symmetrically about its axis of rotation) is placed within, and affixed to, the shaft bore 110, as for example via a conventional key and keyway or via a press fit therebetween. Because the shaft 116 is non-eccentric, its associated motor 118 (see FIG. 7) is any suitable standard electric motor, without any internal balancing for shaft eccentricity as is required by the aforementioned prior art.

Each poppet head clip 124, 126 is clipped onto a respective poppet head drive slot 18, 18′ such as to now be aligned with the poppet drive axis A (see FIG. 6A). When so clipped, the drive surface 20, 20′ of each of the poppet heads 16, 16′ abuts the outer bearing surface 122, and each poppet head clip 124, 126 is interferingly seated in the respective drive slot 18, 18′ such that the poppet heads 16, 16′ must follow movement of the outer bearing surface in both directions along the poppet drive axis A.

Operation will now be detailed. The motor 118 causes the shaft 116 to non-eccentrically rotate, whereupon the inner bearing cylinder 104 rotates eccentrically about the shaft as it rotates in unison with the shaft. The outer bearing ring 106 does not rotating by virtue of the roller or ball bearing 108 interface between the inner bearing cylinder and the outer bearing ring. The eccentric rotation of the inner bearing cylinder is smoothly balanced by the balancing cavity 112, and causes the outer bearing ring to reciprocate back and forth along the poppet drive axis A. This reciprocation effects reciprocation of each of the poppet heads 16, 16′ so as to reciprocably drive the poppets 12, 14.

FIGS. 6A and 6B pictorially summarize the foregoing operative description, in which the eccentricity of the rotation of the inner bearing cylinder is defined by an over-set 130 and an under-set 132. FIG. 6A shows the over-set 130 having pushed-in poppet 14 and the underset having pulled-out poppet 12. With the shaft rotated 180 degrees, FIG. 6B shows the over-set 130 having pushed-in poppet 12 and the underset having pulled-out poppet 14. In this manner, each eccentric rotation of the inner bearing cylinder 104 results in a cycle of reciprocation of the poppets 12, 14.

To those skilled in the art to which this invention appertains, the above described preferred embodiment may be subject to change or modification. Such change or modification can be carried out without departing from the scope of the invention, which is intended to be limited only by the scope of the appended claims.

1. An eccentric bearing, comprising:
an inner bearing cylinder having an outer periphery and an axial center centrally disposed in relation to said outer periphery, said inner bearing cylinder having a shaft bore adapted to receive a motor shaft, said shaft bore being off-set spatially from said axial center, said inner bearing cylinder having a mass distribution therewithin which balances centrifugal forces during rotation of said inner bearing cylinder centrally about said shaft bore;
an outer bearing ring having an inner perphery and an outer bearing surface, a pair of poppet head clips being connected to said outer bearing surface in mutually axial alignment; and
a bearing interface between said outer and inner peripheries.

2. The eccentric bearing of claim 1, wherein said mass distribution comprises a balancing cavity formed in said inner bearing cylinder at a location in line with said axial center and said shaft bore, wherein said shaft bore and said balancing cavity are diametrically disposed with respect to said axial center.

3. A poppet drive system, comprising:
a first poppet having a first poppet head;
a second poppet having a second poppet head; and
an eccentric bearing, comprising:
an inner bearing cylinder having an outer periphery and an axial center centrally disposed in relation to said outer periphery, said inner bearing cylinder having a shaft bore adapted to receive a motor shaft, said shaft bore being off-set spatially from said axial center, said inner bearing cylinder having a mass distribution therewithin which balances centrifugal forces during rotation of said inner bearing cylinder centrally about said shaft bore;
an outer bearing ring having an inner perphery and an outer bearing surface, a pair of poppet head clips being connected to said outer bearing surface in mutually axial alignment; and
a bearing interface between said outer and inner peripheries;
wherein each poppet head clip of said pair of poppet head clips is engaged with said first and second poppet heads, respectively so as to cause said first and second poppet heads to reciprocate as said inner bearing cylinder rotates centrally about said shaft bore.

4. The poppet drive system of claim 3, wherein said first and second poppet heads each have a slot and a drive surface; wherein each said poppet head clip is interferingly received in the slot of a respective one of said first and second poppet heads; and wherein said drive surface of each of said first and second poppet heads abuts said outer bearing surface.

5. The poppet drive system of claim 3, further comprising a motor having a non-eccentric shaft affixed within said shaft bore.

6. The poppet drive system of claim 3, wherein said mass distribution comprises a balancing cavity formed in said inner bearing cylinder at a location in line with said axial center and said shaft bore, wherein said shaft bore and said balancing cavity are diametrically disposed with respect to said axial center.

7. The poppet drive system of claim 4, further comprising a motor having a non-eccentric shaft affixed within said shaft bore.

8. The poppet drive system of claim 7, wherein said mass distribution comprises a balancing cavity formed in said inner bearing cylinder at a location in line with said axial center and said shaft bore, wherein said shaft bore and said balancing cavity are diametrically disposed with respect to said axial center.
